(19) United States
(12) Patent Application Publication
(10) Pub. No.: US 2010/0002866 A1
(43) Pub. Date: Jan. 7, 2010

(54) VOICE COMMUNICATION APPARATUS

(75) Inventor: Shinichi Ozawa, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/493,690

(22) Filed: Jun. 29, 2009

(30) Foreign Application Priority Data
Jul. 1, 2008 (JP) 2008-172539

(51) Int. Cl. H04M 9/08

(52) U.S. Cl. 379/406.06; 379/406.08

(57) ABSTRACT

A voice communicating apparatus in which a far-end voice of high sound quality can be outputted from a loudspeaker and an echo which is caused by the outputted far-end voice can be accurately removed with high precision. An analog far-end voice signal supplied from a telephone unit is directly outputted from the loudspeaker and a digital detection sound signal of the far-end voice and a near-end voice detected by a microphone is delayed by a predetermined time and supplied to an arithmetic operating part.

### BACKGROUND OF THE INVENTION

1. Field of the Invention

The invention relates to a voice communicating apparatus having an echo canceling function.

2. Description of the Related Art

Hitherto, in the voice communication of a telephone line or the like, a problem has been encountered such that the so-called echo occurs, in which a signal supplied to a communication partner is mixed to a signal supplied from the communication partner due to characteristics of a circuit or the like. As a specific example of the echo, there is a case where a microphone of a receiver detects a voice which is outputted from a loudspeaker of the receiver of a telephone and a voice of the user himself/herself transmitted to the communication partner is returned to himself/herself again. There has been a known fact that the echo as noises is mixed to a voice which is uttered by the communication partner to the user himself due to the generation of the echo as mentioned above and it becomes difficult to accurately catch the voice of the communication partner.

As a method for solving the problem mentioned above, there is a method whereby an echo canceller for cancelling the echo is provided in the voice communicating apparatus. The echo canceller predicts the echo as mentioned above and forms a pseudo echo with a delay corresponding to the echo. By subtracting the pseudo echo from the signal received by the echo canceller, the echo as unnecessary sounds can be removed.

An apparatus using a handsfree system as an echo removing process as mentioned above has been disclosed in Japanese patent Kokai No. 2003-338874 (Patent Document 1). In the handsfree system disclosed in Patent Document 1, a telephone unit having a telephone function is connected through a change-over switch to a DSP (Digital Signal Processor) for executing the echo removing process by using a digital filter. A microphone and a loudspeaker are connected to the DSP through a change-over switch different from the change-over switch. Further, in the handsfree system, when the echo is not removed, the telephone unit can be directly connected to the microphone and the loudspeaker through a plurality of change-over switches mentioned above without passing through the DSP.

### SUMMARY OF THE INVENTION

In the case where the echo is removed in the voice communicating apparatus disclosed in Patent Document 1, however, the voice signal of the communication partner (that is, analog far-end voice signal) is certainly supplied to the DSP in order to form a pseudo echo signal. The analog far-end voice signal is, therefore, converted into a digital far-end voice signal in the DSP by an analog/digital (A/D) conversion. Further, the digital far-end voice signal is converted again into an analog far-end voice signal by a digital/analog (D/A) conversion before it is supplied to the loudspeaker. By the A/D conversion and the D/A conversion, sound quality of the analog far-end voice signal which is supplied to the loudspeaker is deteriorated so that the quality becomes lower than that of the analog far-end voice signal which is supplied to the DSP.

The invention has been made in consideration of the circumstances as mentioned above and it is an object of the invention to provide a voice communicating apparatus in which a far-end voice of high sound quality can be outputted from a loudspeaker and an echo which is caused by the outputted far-end voice can be accurately removed at high precision.

To solve the above problem, according to the invention, there is provided a voice communicating apparatus comprising: a first analog/digital (A/D) converting part for receiving an analog far-end voice signal which is supplied from a telephone unit and converting the analog far-end voice signal into a digital far-end voice signal; a pseudo echo signal forming part which forms a pseudo echo signal based on the digital far-end voice signal; a loudspeaker which converts the analog far-end voice signal supplied from the telephone unit into a far-end voice and outputs the far-end voice; a microphone which detects the far-end voice and a near-end voice and forms an analog detection sound signal; a second A/D converting part which converts the analog detection sound signal into a digital detection sound signal; a delay part which delays the digital detection sound signal; an arithmetic operating part which subtracts the pseudo echo signal from the delayed digital detection sound signal, thereby forming a digital difference signal; and a digital/analog (D/A) converting part which converts the digital difference signal into an analog difference signal.

A delay amount of the digital detection sound signal may be determined based on a pseudo echo signal forming time in the pseudo echo signal forming part.

The voice communicating apparatus may further have a delay control part which adjusts the delay amount of the delay part on the basis of a time difference between timing for supplying the digital far-end voice signal to the pseudo echo signal forming part and timing for supplying the digital detection sound signal to the arithmetic operating part.

The pseudo echo signal forming part may be an adaptive filter and the delay control part may adjust the delay amount based on a tap coefficient of the adaptive filter.

The delay control part may reduce the delay amount for a period of time from a point of time when the digital far-end voice signal has been supplied to the adaptive filter to a point of time when an absolute value of the tap coefficient in an impulse response of an echo which is caused by the far-end voice exceeds a predetermined threshold value.

The delay control part may reduce the delay amount for a period of time from a point of time when the digital far-end voice signal has been supplied to the adaptive filter to a point of time when the tap coefficient is equal to zero just before a maximum amplitude in an impulse response of an echo which is caused by the far-end voice.

According to the voice communicating apparatus of the invention, the analog far-end voice signal is directly supplied from the telephone unit to the loudspeaker, the delay part is provided between the second A/D converting part and the arithmetic operating part, and a delay is caused in the detection sound signal, so that the far-end voice of high sound quality can be outputted from the loudspeaker and the echo which is caused by the outputted far-end voice can be accurately removed.

### BRIEF DESCRIPTION OF THE DRAWINGS

FIG. 1 is a diagram showing the structure of a voice communicating apparatus according to the first embodiment of the invention;

FIG. 2 is a flowchart showing transmission and reception of a voice in the voice communicating apparatus according to the first embodiment of the invention;

FIG. 3 is a diagram showing the structure of a voice communicating apparatus according to the second embodiment of the invention; and

FIG. 4 is a graph showing an impulse response of an echo in the voice communicating apparatus according to the second embodiment of the invention.

### DETAILED DESCRIPTION OF THE PREFERRED EMBODIMENTS

Embodiments of the invention will be described in detail hereinafter with reference to the drawings.

### Embodiment 1

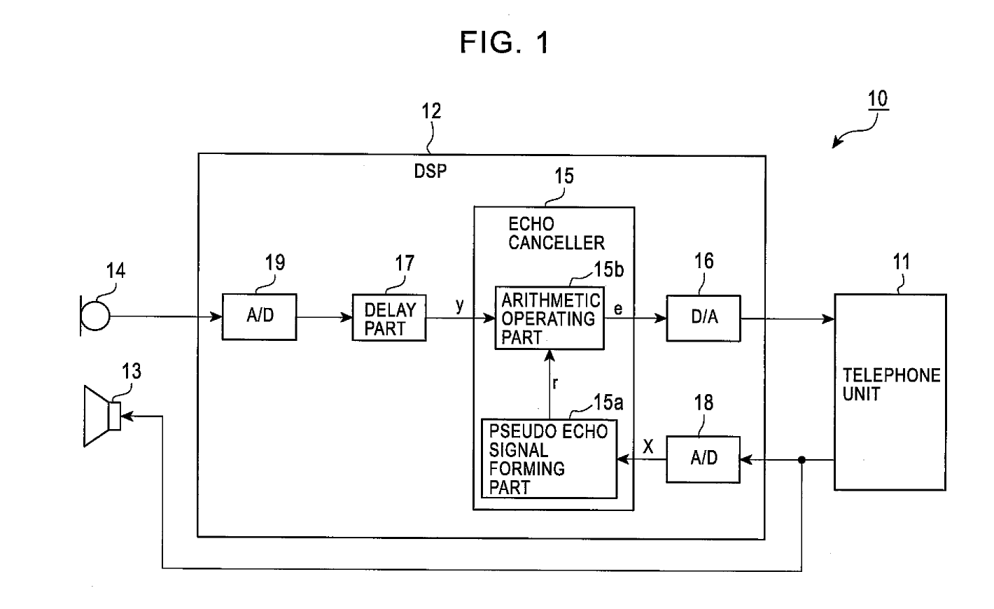

The construction of a voice communicating apparatus in the embodiment of the invention will be described in detail hereinafter with reference to FIG. 1. FIG. 1 is a constructional diagram of a voice communicating apparatus 10 as a first embodiment of the invention.

As shown in FIG. 1, the voice communicating apparatus 10 is constituted by a telephone unit 11, a DSP (Digital Signal Processor) 12, a loudspeaker 13, and a microphone 14. The DSP 12 is constructed by an echo canceller 15, a digital/analog (D/A) converting part 16, a delay part 17, a first analog/digital (A/D) converting part 18, and a second analog/digital (A/D) converting part 19. Further, the echo canceller 15 is constituted by a pseudo echo signal forming part 15a (simply referred to as a pseudo echo forming part hereinafter) and an arithmetic operating part 15b.

The telephone unit 11 has a telephone function for making a speech with a communication partner. The telephone unit 11 can communicate with a telephone unit (not shown) of the communication partner through a telephone line (not shown). The first A/D converting part 18 and the loudspeaker 13 are connected to the telephone unit 11. An analog far-end voice signal which is supplied from the telephone unit 11 is directly supplied to the loudspeaker 13 (that is, by bypassing the DSP 12). The analog far-end voice signal is converted into a far-end voice by the loudspeaker 13 and outputted to the outside. That is, since the far-end voice which is outputted from the loudspeaker 13 is not subjected to the A/D conversion and the D/A conversion, it has high sound quality. The first A/D converting part 18 converts the analog far-end voice signal generated from the telephone unit 11 into a digital far-end voice signal (also simply referred to as a far-end voice signal hereinbelow). Further, the first A/D converting part 18 is connected to the pseudo echo forming part 15a provided for the echo canceller 15. The first A/D converting part 18 supplies the far-end voice signal to the pseudo echo forming part 15a. The pseudo echo forming part 15a forms a pseudo echo signal for a removing process of the echo from the far-end voice signal. A case where the pseudo echo forming part is constructed by an adaptive digital filter (ADF) will be described as an example hereinbelow. The ADF is simply referred to as an adaptive filter hereinbelow.

The microphone 14 is connected to the second A/D converting part 19. The microphone 14 converts all sounds which are detected into an analog signal and supplies to the second A/D converting part 19. That is, the microphone 14 detects a far-end voice which is outputted from the loudspeaker 13 besides a near-end voice which is uttered by the talking person. The microphone 14, therefore, detects the near-end voice and the far-end voice and converts into an analog detection sound signal. A portion regarding the far-end voice of the analog detection sound signal is called an analog echo signal. Further, the analog detection sound signal is supplied to the second A/D converting part 19. The second A/D converting part 19 is connected to the delay part 17. The second A/D converting part 19 converts the analog detection sound signal sent from the microphone 14 into a digital detection sound signal (also simply referred to as a detection sound signal hereinbelow). A portion regarding the far-end voice of the digital detection sound signal is called a digital echo signal here or is simply referred to as an echo signal. Further, the second A/D converting part 19 supplies the detection sound signal to the delay part 17.

The delay part 17 is connected to the arithmetic operating part 15b of the echo canceller 15. The delay part 17 delays the received detection sound signal by a predetermined time and, thereafter, supplies to the arithmetic operating part 15b. The delay time (also referred to as a delay amount hereinbelow) in the delay part is preset to a proper value on the basis of a use environment or the like of the voice communicating apparatus 10. That is, the delay amount is a value which can be properly changed. For example, the delay amount may be set by a time interval until the far-end voice outputted from the loudspeaker 13 is detected by the microphone 14. A path of the far-end voice from the loudspeaker 13 to the microphone 14 may be a direct path or a path accompanied with a reflection that is caused by ambient walls or the like where the voice communicating apparatus 10 has been disposed. The delay amount is determined in such a manner that the detection sound signal is not supplied to the arithmetic operating part 15b before the pseudo echo signal in the adaptive filter 15a is formed. That is, the delay amount is determined based on the time when the pseudo echo signal has been formed in the adaptive filter 15a.

As mentioned above, the echo canceller 15 is constituted by the adaptive filter 15a and the arithmetic operating part 15b and transmits and receives predetermined data. An internal process of the echo canceller 15 will be described below.

The adaptive filter 15a applies an arithmetic operation to the far-end voice signal by its own tap coefficient, thereby forming the pseudo echo signal. Now, assuming that the reception signal at discrete time t is set to X=X(t) and the tap coefficient is set to H=H(t), the far-end voice signal and the tap coefficient are obtained by the following equations (1) and (2).

H(t)=[h1(t), h2(t), . . . , hm(t)]⁷ (1)

X(t)=[x(t), x(t−1), . . . , x(t−m+1)]^{T} (2)

where a superscript character “T” denotes a transposition of a vector.

The adaptive filter 15a supplies the pseudo echo signal formed by the arithmetic operation to the arithmetic operating part 15b. The arithmetic operating part 15b subtracts the pseudo echo signal from the detection sound signal, thereby forming a digital difference signal (also simply referred to as a difference signal hereinbelow). The arithmetic operating part 15b is also connected to the D/A converting part 16 and supplies the difference signal to the D/A converting part 16. Now, assuming that the pseudo echo signal is set to r=r(t), the detection sound signal is set to y=y(t), and the difference signal is set to e=e(t), the pseudo echo signal and the difference signal are obtained by the following equations (3) and (4).

r(t)=H(t)^{T}X(t) (3)

e(t)=y(t)−r(t) (4)

The D/A converting part 16 is connected to the telephone unit 11. The D/A converting part 16 converts the difference signal supplied from the arithmetic operating part 15b into an analog difference signal. Further, the D/A converting part 16 supplies the analog difference signal to the telephone unit 11. The analog difference signal is converted into a predetermined voice signal by the telephone unit 11 and supplied to the communication partner as a far-end talking person through a telephone line.

In the case where the analog far-end voice signal sent from the telephone unit 11 is generated as a far-end voice signal from the loudspeaker 13, the sound quality can be improved as compared with that in the case where the analog far-end voice signal from the telephone unit 11 is A/D converted and is further returned to the analog far-end voice signal by the D/A conversion in a manner similar to that in the related art. Since it takes a time to form the pseudo echo signal, when the pseudo echo signal is subtracted from the detection sound signal by the arithmetic operating part, a deviation of the subtracting timing occurs. The accurate removing process of the echo, therefore, cannot be executed.

With respect to the above point, in the voice communicating apparatus 10 in the embodiment, the delay part 17 is arranged between the second A/D converting part 19 and the arithmetic operating part 15b and the delay is caused in the detection sound signal, so that the subtracting timing in the arithmetic operating part 15b can be matched. In the voice communicating apparatus 10 in the embodiment, consequently, the far-end voice of the high sound quality can be obtained and the accurate echo removing process of high performance can be realized.

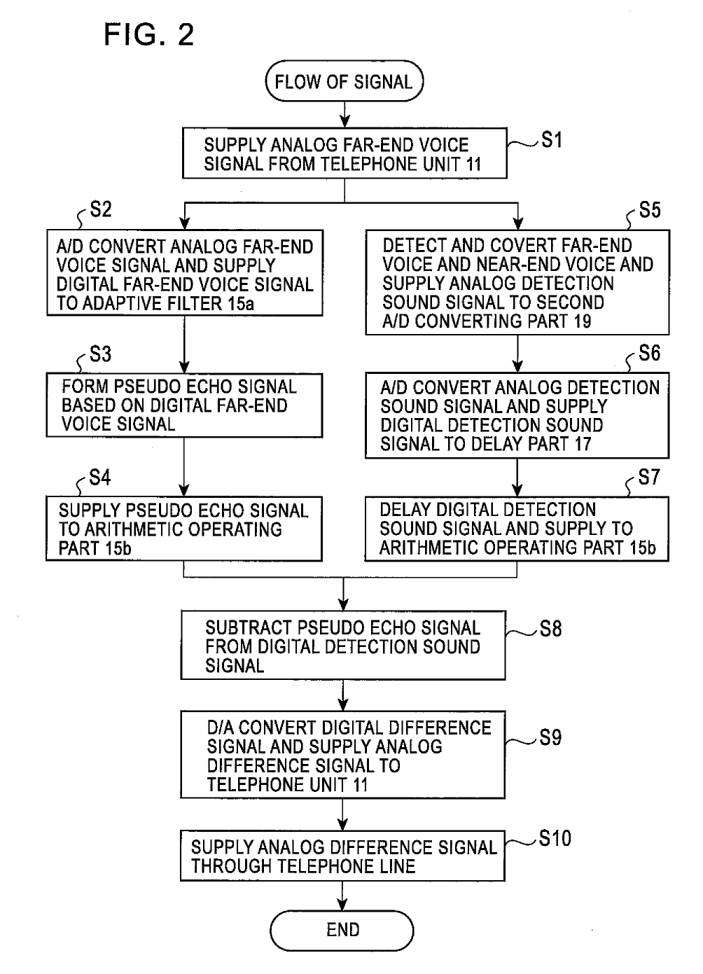

Subsequently, a flow of the signal used in the voice communicating apparatus in the embodiment of the invention will be described in detail with reference to a flowchart of FIG. 2.

First, as shown in FIG. 1, the voice signal from the far-end talking person is supplied to the telephone unit 11 through a predetermined telephone line. The voice signal from the far-end talking person is converted into the analog far-end voice signal and supplied from the telephone unit 11 to the first A/D converting part 18 and the loudspeaker 13 (step S1).

Subsequently, the first A/D converting part 18 converts the received analog far-end voice signal into a digital far-end voice signal (also simply referred to as a far-end voice signal hereinbelow). The first A/D converting part 18 supplies the far-end voice signal to the adaptive filter 15a (step S2). The adaptive filter 15a forms the pseudo echo signal based on the received far-end voice signal (step S3). Specifically speaking, the adaptive filter 15a arithmetically operates the far-end voice signal by a tap coefficient, thereby forming the pseudo echo signal. Further, the adaptive filter 15a supplies the formed pseudo echo signal to the arithmetic operating part 15b (step S4).

The analog far-end voice signal supplied from the telephone unit 11 to the loudspeaker 13 is converted into the far-end voice by the loudspeaker 13 and transmitted to the outside. In accordance with the far-end voice outputted from the loudspeaker 13, the near-end voice (that is, a response of a speech or the like) is transmitted toward the microphone 14 by the talking person. The microphone 14 detects the far-end voice and the near-end voice, converts the detected voices into an analog detection sound signal, and supplies it to the second A/D converting part 19 (step S5).

Subsequently, the second A/D converting part 19 converts the analog detection sound signal which is supplied from the microphone 14 into a digital detection sound signal (also simply referred to as a detection sound signal hereinbelow). Further, the A/D converting part 19 supplies the detection sound signal to the delay part 17 (step S6). The delay part 17 delays the supplied detection sound signal by a predetermined time and, thereafter, supplies the signal to the arithmetic operating part 15b (step S7).

Subsequently, the arithmetic operating part 15b subtracts the pseudo echo signal formed in step S3 from the supplied detection sound signal, thereby forming a digital difference signal (also simply referred to as a difference signal hereinbelow) (step S8). Since the pseudo echo signal is formed based on the far-end voice signal, by subtracting the pseudo echo signal from the detection sound signal, the echo caused by the far-end voice outputted from the loudspeaker 13 is efficiently eliminated.

Subsequently, the arithmetic operating part 15b supplies the difference signal to the D/A converting part 16. The D/A converting part 16 converts the difference signal into an analog difference signal (step S9). The D/A converting part 16 supplies the analog difference signal to the telephone unit 11. Further, the analog difference signal is supplied from the telephone unit 11 to a telephone unit of the communication partner through the telephone line (step S10).

As mentioned above, in the voice communicating apparatus 10 of the invention, by directly supplying the analog far-end voice signal from the telephone unit 11 to the loudspeaker 13, the far-end voice of the high sound quality can be outputted from the loudspeaker 13. In the voice communicating apparatus 10 of the invention, the delay part 17 is arranged between the second A/D converting part 19 and the arithmetic operating part 15b and the delay is caused in the detection sound signal, so that the subtracting timing for the echo removing process in the arithmetic operating part 15b can be matched. In the voice communicating apparatus 10 in the embodiment, consequently, the far-end voice of high sound quality can be outputted from the loudspeaker 13 and the echo caused by the outputted far-end voice can be accurately eliminated.

### Embodiment 2

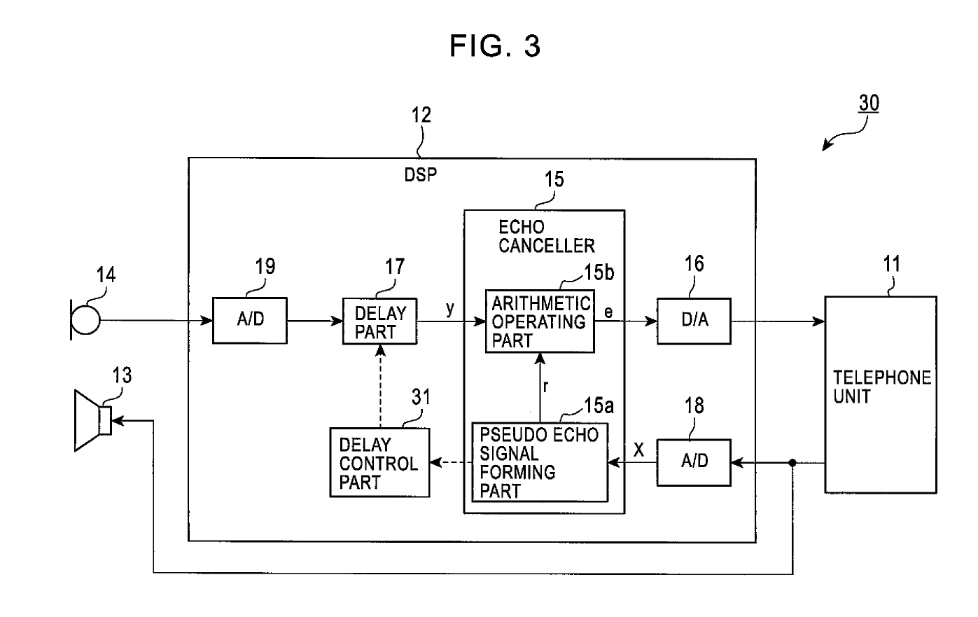

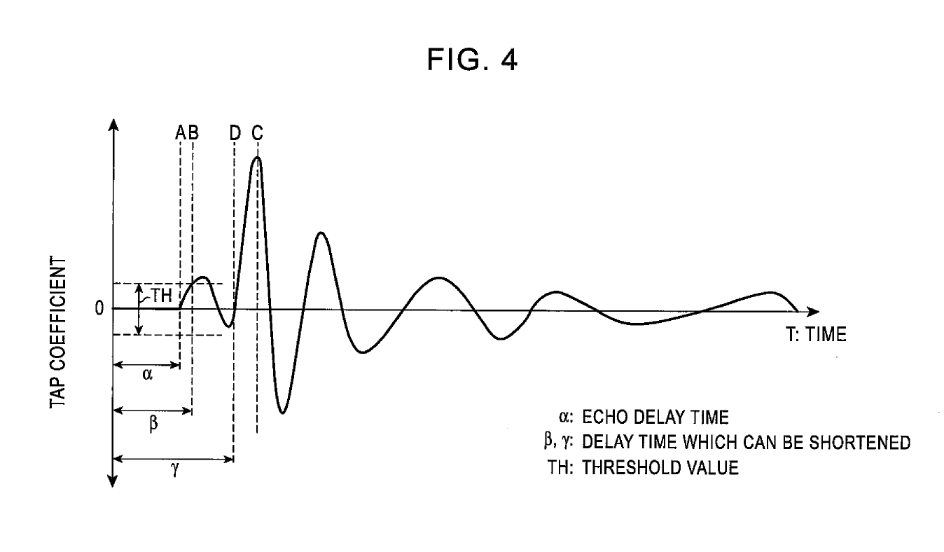

Although the delay amount of the detection sound signal in the delay part has been preset in the first embodiment, a delay control part for controlling the delay amount based on an impulse response to the echo caused by the far-end voice outputted from the loudspeaker may be further provided. In the voice communicating apparatus having the delay control part as mentioned above, even in the case where the time until the far-end voice outputted from the loudspeaker 13 is detected by the microphone 14 is not previously clear, the subtracting timing for the detection sound signal and the pseudo echo signal in the arithmetic operating part can be accurately matched and the more accurate echo removing process of the high performance can be realized. The voice communicating apparatus having the delay control part for controlling the delay amount in the delay part 17 as mentioned above will now be described in detail with reference to FIGS. 3 and 4. A description of a construction similar to that in the first embodiment is omitted here. Component portions similar to those in the first embodiment are designated by the same reference numerals.

As shown in FIG. 3, a voice communicating apparatus 30 further has a delay control part 31 connected to the adaptive filter 15a of the echo canceller 15 and to the delay part 17. The delay control part 31 controls the delay amount of the detection sound signal in the delay part 17 based on the information data which is supplied from the adaptive filter 15a. Specifically speaking, the delay control part 31 controls the delay amount in the delay part 17 based on the tap coefficient of the adaptive filter 15a. That is, the delay control part 31 newly determines the delay amount in the delay part 17 on the basis of the time difference between the timing for supplying the far-end voice signal to the adaptive filter 15a and the timing for supplying the detection sound signal to the arithmetic operating part 15b. A flow of the signal regarding the control of the delay amount is shown by arrows of broken lines.

A specific example of determining the delay amount in the delay control part 31 will be described in detail with reference to FIG. 4. FIG. 4 shows an impulse response of the echo in the preset delay amount. An axis of abscissa indicates a time and an axis of ordinate indicates the tap coefficient of the adaptive filter 15a. Time zero (T=0) of the axis of abscissa is a time when the far-end voice signal has been supplied to the adaptive filter 15a. Time A (position where the axis of abscissa and a broken line A cross) is a time when the echo signal has been supplied to the arithmetic operating part 15b. That is, the delay time of the echo is shown by a period of time α (shown by a bidirectional arrow α). The period of time α indicates a delay time until the far-end voice outputted from the loudspeaker 13 is returned as an echo and is a coefficient which is unnecessary to form the pseudo echo signal. That is, in the impulse response of the echo shown in FIG. 4, the preset delay amount in the delay part 17 is reduced and the delay time of the echo can be shortened.

As a method of determining the delay time which can be shortened, an absolute value of an amplitude (that is, an absolute value of the tap coefficient) in FIG. 4 is compared with a preset threshold value and a period of time from a point of time of time zero (T=0) to a point of time when the amplitude first exceeds the threshold value is calculated. As shown in FIG. 4, assuming that the threshold value is set to TH, the point of time when the amplitude first exceeds the threshold value TH is time B (position where the axis of abscissa and a broken line B cross). That is, the delay time can be shortened by a period of time β (shown by a bidirectional arrow β) as a time from the point of time of time zero (T=0) to time B. The delay control part 31 adjusts so that the time shortened by the period of time β from the preset delay amount is equal to the delay amount.

By resetting the time shortened by the period of time β as mentioned above as a delay amount, the number of valid tap coefficients of the adaptive filter 15a is increased (in other words, an overlap portion of the echo signal and the pseudo echo signal is increased) and the accurate echo removing process of the high performance can be realized. The control of the delay amount as mentioned above becomes effective particularly in the case of eliminating the long echo signal.

The threshold value may be a predetermined value so long as the time when there are no influences on the echo canceller 15 can be detected. The threshold value may be calculated by the following equation (5).

TH=|maximum amplitude|÷C(C is a fixed value) (5)

where the maximum amplitude is an amplitude at time C (position where the axis of abscissa and a broken line C cross) in FIG. 4.

The method of determining the delay time which can be shortened is not limited to the foregoing method whereby the threshold value is used but may be the following method.

A time (referred to as a zero-cross position hereinbelow) when the graph of the impulse response of the echo first (that is, just before the maximum amplitude) passes through a spot of the amplitude zero (0) when directing from time C indicative of the maximum amplitude in FIG. 4 toward time zero (T=0) is calculated. In FIG. 4, time D (position where the axis of abscissa and a broken line D cross) is the zero-cross position. The delay control part 31 can shorten a period of time γ (shown by a bidirectional arrow γ) as an elapsed time from time zero (T=0) to the zero-cross position. A delay amount obtained by subtracting the period of time γ from the preset delay amount is set as a new delay amount.

By providing the delay control part 31 in the second embodiment as mentioned above, the delay amount can be further optimally adjusted. For example, if a distance from the loudspeaker 13 to the microphone 14, an extent of a room where the voice communicating apparatus 30 is disposed, and the like are not predetermined, there is also a case where it is difficult to accurately predetermine the delay amount of the echo which is influenced on the direct path of the far-end voice from the loudspeaker 13 to the microphone 14, a path accompanied with a reflection that is caused by the ambient walls or the like where the voice communicating apparatus 30 has been disposed or the like. In the second embodiment, even in such a situation that it is difficult to accurately predetermine the delay amount of the echo, the delay amount in the delay part 17 can be set to the optimum value by the delay control part 31. The echo canceller 15, therefore, can effectively use all of the tap coefficients and can also delete the long echo without increasing the number of valid tap coefficients. In such a situation that no long echo is caused, the number of valid tap coefficients is decreased and a processing amount of the echo canceller 15 can be reduced.

This application is based on Japanese Patent Application No. 2008-172539 which is incorporated herein by reference.

What is claimed is:

1. A voice communicating apparatus comprising:
a first analog/digital (A/D) converting part which receives an analog far-end voice signal supplied from a telephone unit and converts said analog far-end voice signal into a digital far-end voice signal;
a pseudo echo signal forming part which forms a pseudo echo signal based on said digital far-end voice signal;
a loudspeaker which converts said analog far-end voice signal supplied from said telephone unit into a far-end voice and outputs said far-end voice;
a microphone which detects said far-end voice and a near-end voice and forms an analog detection sound signal;
a second A/D converting part which converts said analog detection sound signal into a digital detection sound signal;
a delay part which delays said digital detection sound signal;
an arithmetic operating part which subtracts said pseudo echo signal from said delayed digital detection sound signal, thereby forming a digital difference signal; and
a digital/analog (D/A) converting part for converting said digital difference signal into an analog difference signal.

2. An apparatus according to claim 1, wherein a delay amount of said digital detection sound signal is determined based on a pseudo echo signal forming time in said pseudo echo signal forming part.

3. An apparatus according to claim 1, further comprising a delay control part which adjusts said delay amount of said delay part based on a time difference between a timing of supplying said digital far-end voice signal to said pseudo echo signal forming part and a timing of supplying said digital detection sound signal to said arithmetic operating part.

4. An apparatus according to claim 3, wherein said pseudo echo signal forming part is an adaptive filter and said delay control part adjusts said delay amount based on the tap coefficient of said adaptive filter.

5. An apparatus according to claim 4, wherein said delay control part reduces said delay amount for a period of time from a point of time when said digital far-end voice signal has been supplied to said adaptive filter to a point of time when an absolute value of the tap coefficient in an impulse response of an echo which is caused by said far-end voice exceeds a predetermined threshold value.

6. An apparatus according to claim 4, wherein said delay control part reduces said delay amount for a period of time from a point of time when said digital far-end voice signal has been supplied to said adaptive filter to a point of time when the tap coefficient is equal to zero just before a maximum amplitude in an impulse response of an echo which is caused by said far-end voice.

7. An apparatus according to claim 2, further comprising a delay control part which adjusts said delay amount of said delay part based on a time difference between a timing of supplying said digital far-end voice signal to said pseudo echo signal forming part and a timing of supplying said digital detection sound signal to said arithmetic operating part.

8. An apparatus according to claim 7, wherein said pseudo echo signal forming part is an adaptive filter and said delay control part adjusts said delay amount based on the tap coefficient of said adaptive filter.

9. An apparatus according to claim 8, wherein said delay control part reduces said delay amount for a period of time from a point of time when said digital far-end voice signal has been supplied to said adaptive filter to a point of time when an absolute value of the tap coefficient in an impulse response of an echo which is caused by said far-end voice exceeds a predetermined threshold value.

10. An apparatus according to claim 8, wherein said delay control part reduces said delay amount for a period of time from a point of time when said digital far-end voice signal has been supplied to said adaptive filter to a point of time when the tap coefficient is equal to zero just before a maximum amplitude in an impulse response of an echo which is caused by said far-end voice.
